(19) United States
(12) Patent Application Publication
(10) Pub. No.: US 2008/0094389 A1
(43) Pub. Date: Apr. 24, 2008

(54) Image Processing System for Automatic Segmentation of a 3-D Tree-Like Tubular Surface of an Object, Using 3-D Deformable Mesh Models

(75) Inventors: Jean-Michel Rouet, Paris (FR); Franck Laffargue, Poissy (FR); Maxim Fradkin, Paris (FR)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/569,166

(22) PCT Filed: May 9, 2005
(86) PCT No.: PCT/IB05/51500

§ 371 Date: Nov. 16, 2006

(30) Foreign Application Priority Data
May 18, 2004 (EP) 04300288.0

(51) Int. Cl. G06T 15/00

(52) U.S. Cl. 345/419

(57) ABSTRACT

An image data processing system with computing means for the automatic segmentation of a treelike tubular structure in a 3-D image comprising: means (20) for computing a treelike center path of the tubular tree-like structure; means (21) for dividing the treelike center path of the tubular treelike structure into segments formed of points; means (40) for generating generic cylindrical meshes formed of cells, for individual segments of the tree-like center path; means (50) for fusing generic cylindrical meshes by two.

### FIELD OF THE INVENTION

The invention relates to an image processing system for automatic segmentation of a 3-D tree-like tubular surface of an object in a three-dimensional image, using 3-D deformable mesh models. The invention also relates to a medical examination apparatus using such a system. The invention further relates to program products for processing medical three-dimensional images produced by this apparatus. The invention also relates to a medical image processing method for the segmentation of tubular tree-like body organs such as arteries, for improving the visualization of the organs. The invention finds a particular application in the field of medical imaging.

### BACKGROUND OF THE INVENTION

A technique of modelization of a 3-D object is already disclosed by H. DELINGETTE in the publication entitled “Simplex Meshes: a General Representation for 3D shape Reconstruction” in the “processing of the International Conference on Computer Vision and Pattern Recognition (CVPR '94), 20-24 Jun. 1994, Seattle, USA”. In this paper, a physically based approach for recovering three-dimensional objects is presented. This approach is based on the geometry of “Simplex Meshes”. Elastic behavior of the meshes is modeled by local stabilizing functions controlling the mean curvature through the simplex angle extracted at each vertex (node of the mesh). Those functions are viewpoint-invariant, intrinsic and scale-sensitive. A Simplex Mesh has constant vertex connectivity. For representing 3-D surfaces, Simplex Meshes, which are called two-Simplex Meshes, where each vertex is connected to three neighboring vertices, are used. The structure of a Simplex Mesh is dual to the structure of a triangulation as illustrated by the FIG. 1 of the cited publication. The contour on a Simplex Mesh is defined as a closed polygonal chain consisting of neighboring vertices on the Simplex Mesh. Four independent transformations are defined for achieving the whole range of possible mesh transformations. They consist in inserting or deleting edges in a face. The description of the Simplex Mesh also comprises the definition of a Simplex Angle that generalized the angle used in planar geometry; and the definition of metric parameters, which describe how the vertex is located with respect to its three neighbors. Dynamic of each vertex is given by a Newtonian law of motion. The deformation implies a force that constrains the shape to be smooth and a force that constrains the mesh to be close to the 3-D object. Internal forces determine the response of a physically based model to external constraints. The internal forces are expressed so that they be intrinsic viewpoint invariant and scale dependant. Similar types of constraints hold for contours. Hence, the cited publication provides a simple model for representing a given 3-D object. It defines the forces to be applied in order to reshape and adjust the model onto the 3-D object of interest.

### SUMMARY OF THE INVENTION

In medical images, it is often required to segment tree-like tubular organs like arteries. A segmentation based on deformable models allows to extracting clinical parameters of the studied organ like the diameter or the volume. Problems arise when the deformable model, whether of the kind called 2-Simplex Mesh, triangular Mesh or of any other kind of active contour Models, must fit an organ that presents a tree-like tubular structure. It is very difficult to map the discrete deformable model onto the different branches of the tree-like tubular organ, particularly at the location of the embranchments. First, tubular models must be generated to represent each of the different branches. In particular, the tubular models must be adapted to the bends or curvatures of the individual branches. Then, the tubular models must be further merged or fused at the embranchments. If the merging of the tubular models is not correct, there may be gaps or folds or other deformations at embranchment locations.

The present invention has for an object to propose an image processing system for tree-like tubular structure segmentation. The system of the invention has means for fast tree-like tubular surface mesh generation, comprising automatic branch generation, branch labeling and branch fusing, based on cylindrical surface mesh generation. In particular, said system has processing means for creating and using 2-simplex mesh models or triangular mesh models or any other deformable mesh models.

The processing means create the tree-like tubular surface mesh from a tree-like object centerline. This centerline structure is divided into segments corresponding to the different parts of the tree-like tubular object. Then, the segments are used to create region labeled generic cylinders, which are fused to finally create the desired tubular-tree-like mesh surface. The tree-like mesh surface can be used for 3-D image segmentation. This is particularly useful for tree-shaped tubular organs or organ parts like coronary tree, bronchial tree, aorta cross branching, brain vessels, etc.

The invention has for a further object to propose such a system having processing means to minimize the number of branch fusions. Since the system has means to automatically label the generated tree-like tubular mesh surfaces according to the various branches of the initial tubular tree, the labeling defines various regions of the final tree-like tubular mesh. A first cylindrical structure is generated from the greatest possible number of adjacent centerline segments, in a continuous manner. Then other cylindrical structures are fused to this first cylindrical structure. Creating this first cylindrical structure, which directly forms a main branch from several adjacent centerline segments, to which other branches are fused, minimizes the number of fusions operations. The same principle may be applied to the other branches with sub-branches. Labeling the different regions of the object of interest is of great help while using the mesh as an active model for 3D tree-like organ segmentation in 3-D medical images.

The object of interest may be represented in gray level in 3-D images.

The main features of the proposed image processing system are claimed in Claim 1. Other Claims relate to method steps for operating the system means, to a program product or a program package for carrying out the method, and to a medical examination apparatus having 3-D imaging means and a system as in Claim 1.

### BRIEF DESCRIPTION OF THE DRAWINGS

The invention is described hereafter in detail in reference to the following diagrammatic drawings, wherein:

FIG. 1A is a functional block diagram of a viewing system for segmentation of a treelike tubular organ in a 3-D image; FIG. 1B is a functional block diagram of the fusing means of the system;

FIG. 2 illustrates the step of mesh bending segment by segment, based on a predetermined path of ordered points;

FIG. 3A and FIG. 3B illustrate respectively mesh creation without and with linear transformation blending, in circle views;

FIG. 4A illustrates mesh creation without linear transformation blending, in simplex mesh views; FIG. 4B illustrates mesh creation, in simplex mesh views, with linear transformation blending and with radius reduction, leading to torsion minimization; FIG. 4C shows an example of mesh creation using minimal rotation between sub-segments, without radius reduction;

FIG. 5A to FIG. 5C illustrate the generation of an intersection region between two mesh models for creating an embranchment: FIG. 5A illustrates the detection and deletion of faces belonging to the interior of the opposite meshes; FIG. 5B illustrates the coupling and linking of open contours for creating new faces resulting in a new union of the two meshes; FIG. 5C illustrates the new region of union;

FIG. 6A shows an initial tree-like tubular structure, such as an organ in a 3-D image; FIG. 6B shows the centerline of the 3-D tree-like tubular structure of FIG. 6A;

FIG. 7A illustrates the generation of tubular mesh models fitting branches of the tree-like structure, based on the respective parts of centerlines; FIG. 7B illustrates the coupling of one branch of tubular mesh model to another branch; FIG. 7C illustrates the further coupling of another branch of tubular mesh model to the previously constructed tree-like tubular mesh model;

FIG. 8 is a functional block diagram of a medical examination apparatus using the system of FIG. 1.

### DESCRIPTION OF THE PREFERRED EMBODIMENTS

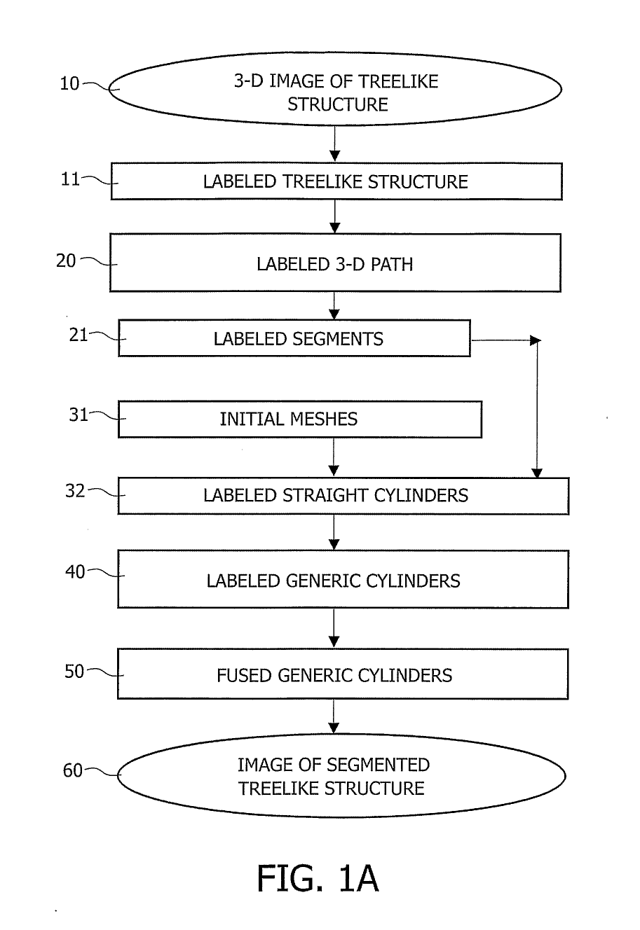

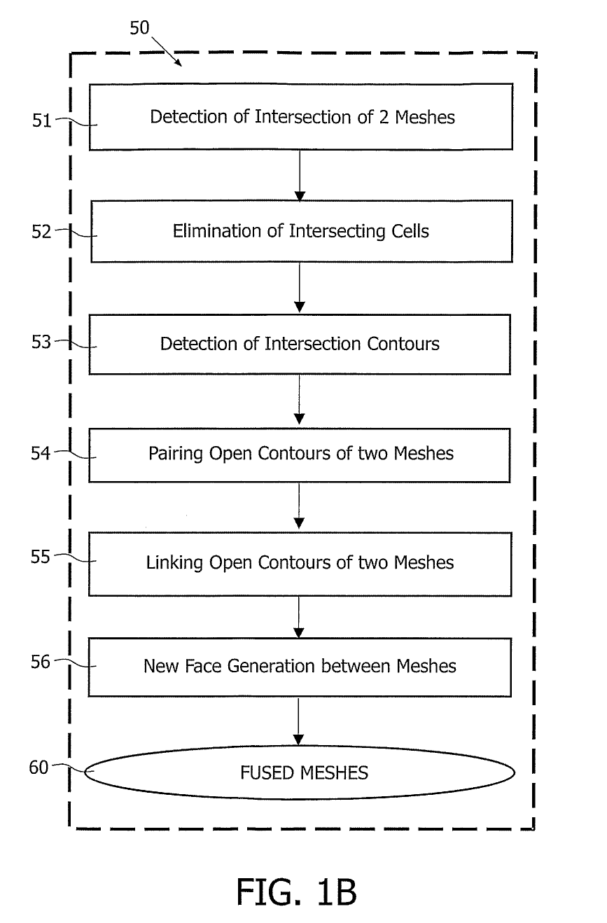

The invention relates to an image processing system with means of processing three-dimensional (3-D) digital image data. FIG. 1A is a diagrammatic representation of an embodiment of this system. The 3-D image 10 may represent in gray levels the three-dimensional surface of a tubular organ called object of interest OI in a noisy image. In order to provide the user with a better view of the object of interest, for instance with respect to the noisy background, this object is segmented. Segmentation permits the user to better study or detect abnormalities of the organ. The images can be acquired by different acquisition means such as ultrasound or X-ray apparatus or by other apparatus known to those skilled in the art.

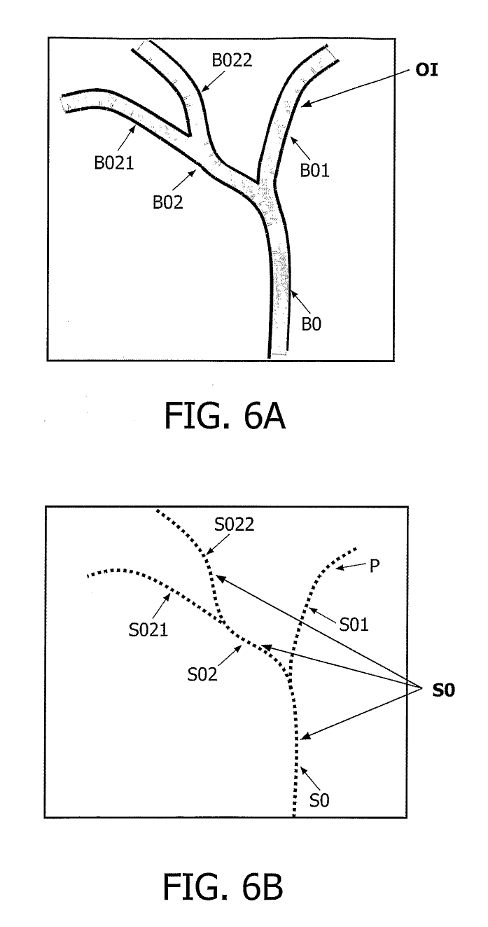

The present invention particularly relates to such an image processing system with means of segmentation of a tree-like tubular object of interest, in a three-dimensional image 10 or in a sequence of three-dimensional images. As illustrated by FIG. 6A, the tree-like tubular object to segment may be a tree-like tubular organ such as a group of blood vessels. The image segmentation technique of the system means is based on the utilization of 3-D deformable models, called active contours. According to the invention, any technique of creating a 3-D deformable model can be used without restriction. The segmentation operation consists in mapping the 3-D deformable model onto the 3-D tree-like tubular object of interest. In the example of a group of blood vessels illustrated by FIG. 6A, the tree-like tubular object of interest shows a complex tubular shape comprising branches, which branches comprise bends.

In the field of active contours, an initial mesh model has to be provided. Even if it is always possible to start from any arbitrary shape of the mesh model, it is more robust and faster to start with a mesh model whose shape is close to the desired shape of the organ to be segmented. According to the invention, creating an initial tubular mesh model of the kind called 2-simplex mesh, triangular mesh or any other kind of mesh model is proposed. Referring to FIG. 1A, the system has means 31 for the user to initialize a tubular mesh model.

As illustrated by FIG. 6A, the object of interest OI is tree-like shaped, thus showing branches B. Referring to FIG. 1A, the system has means 11 of automatically labeling the different parts of the object of interest, using any technique known to those skilled in the art. The system has means 20 to create a 3-D path formed of a set of ordered points. The means 20 generates the tree-like 3-D path P, preferably based on the centerline points of the tubular object of interest OI, as illustrated by FIG. 6B. This centerline structure P is divided into segments S corresponding to the different parts of the tree-like object OI. Then the system has means 21 of labeling the segments S according to the different parts of the object of interest.

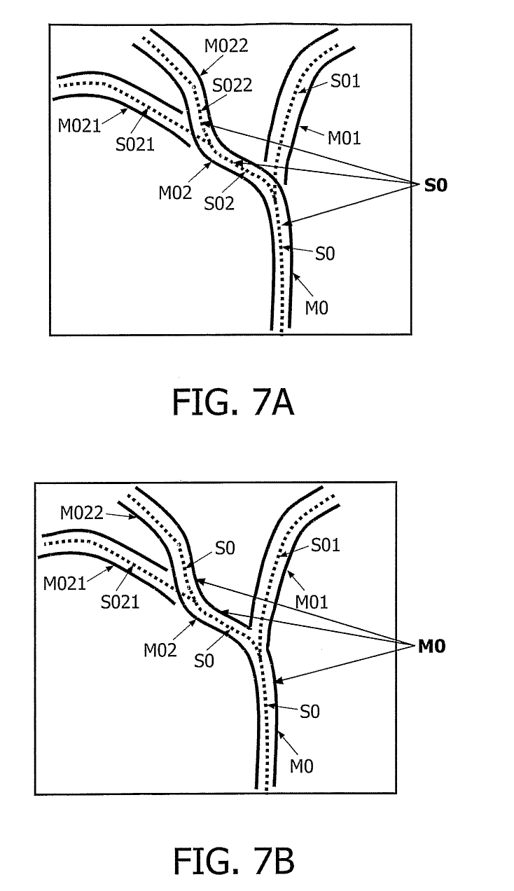

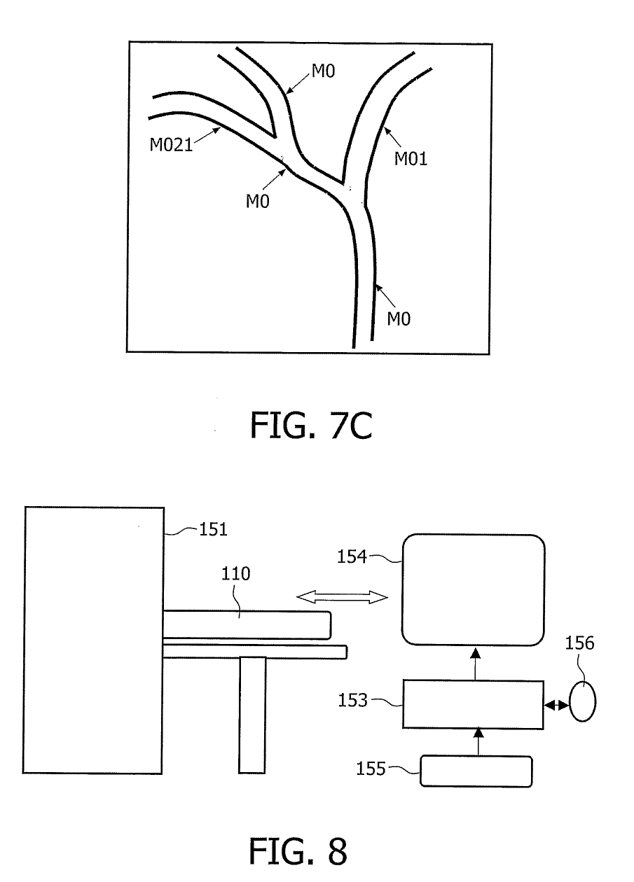

The system has further means 32, 40 of separately creating region labeled generic bent cylinders M, using the labeled segments, as illustrated by FIG. 7A. The means 32 performs the creation of straight cylinders, which are in turn bended into the generic cylinders using the transformation means 40, in order to fit the 3-D path segments. Then the system has fusing means 50 for fusing the generic cylinders M to finally create the desired tubular-tree-like mesh surface, in 3-D images 60 of the segmented treelike object, as illustrated by FIG. 7B and FIG. 7C.

Difficulties first lie in the operation of deforming a straight initial tubular deformable model appropriately in order to map correctly each branch surface of the tubular body organ; and second in the operation of fusing the branches to correctly construct the surface of segmentation of the tree-like tubular body organ.

The tree-like tubular structure OI may have branches B. According to the invention, the system has means 11 for automatic labeling of the different branches B of the tree-like structure. In FIG. 6A, the labeling yields branch B0, then branches B01 and B02, which form an embranchment from B0, and branches B021 and B022, which form an embranchment from B02.

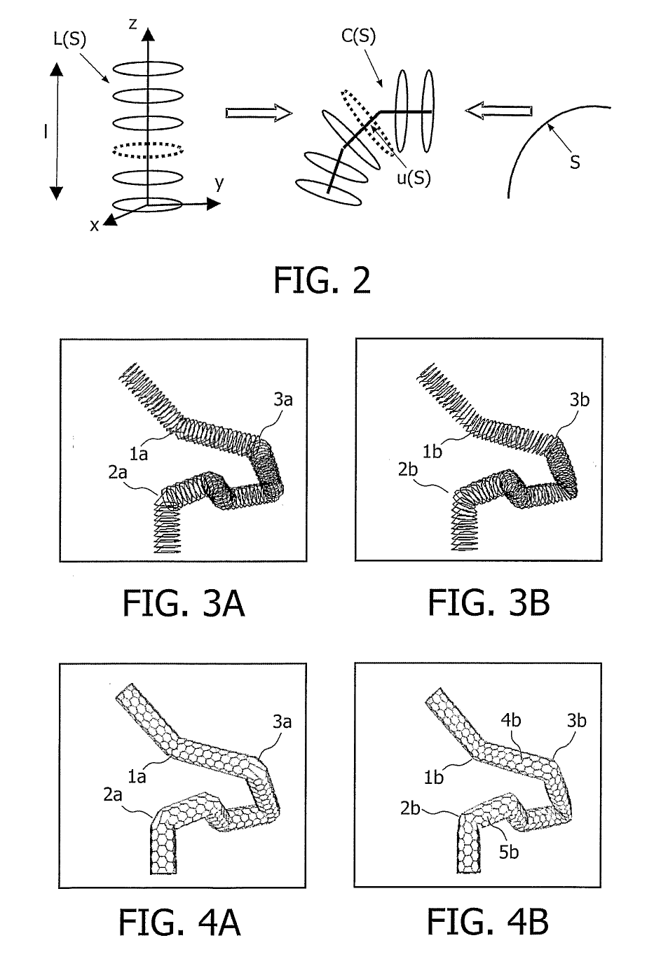

Referring to FIG. 2 and to FIG. 6A, segmentation of a tree-like tubular structure OI, like a structure of blood vessels, comprises to first create the centerline, called 3-D path P, of said tree-like tubular structure OI as illustrated by FIG. 6B. Referring to FIG. 1A, the system has means 20 for generating the path P formed of center points. Path-tracking tools are already known to those skilled in the art and may be used to determine the centerline of the tubular object of interest to be segmented. The centerline structure P is divided into segments S corresponding to the different labeled branches of the tree-like object OI, as illustrated by FIG. 6B. Referring to FIG. 1A, the system has means 21 for labeling the segments S in correspondence to the different branches, such as: segment S0 corresponding to the branch B0 of OI; then segments S01 and S02, corresponding to the branches B01 and B02 and forming an embranchment from S0; and segments S021 and S022, which correspond to the branches B021 and B022 and that form an embranchment from S02. Each segment S of P is a 3-D path that usually shows bents.

Each 3-D labeled segment S of P may be processed separately. As illustrated by FIG. 2, each segment S of P is first converted into an initial straight cylindrical mesh model, which is further deformed to fit the actual shape of the tubular segment of the organ. For this, a technique is provided in order to initialize a mesh model from such a 3-D segment S of path P, instead of initializing a mesh model directly with an object surface as in the prior art publication [Delingette]. Any application aiming at segmenting tubular structures might benefit from an initial mesh model having a tubular shape. According to the invention, the system has means 31, 32, 40 for creating separate tubular mesh models fitting each branch of the tree-like tubular organ to be segmented. The inputs are:

1) a sorted list of points lying along each segment S of the 3-D path P. No assumptions are required yet on regularity and spacing of these points, but such constraints can help in obtaining a smooth mesh model.

2) the radius r of the cylinder, and

3) the resolution of the cells.

The natural output is a mesh structure M for each segment S of the path P.

Referring to FIG. 2, a technique for creating the cylinder basic form is proposed. This technique consists in creating along the z-axis of a predefined referential Ox, Oy, Oz, a set of points lying on circular sections of the initial cylindrical mesh model, then linking the sets of points all together to create the simplex mesh structure. For generating a 3-D flexible tube denoted by C(S), the technique of the invention comprises starting from the straight cylinder denoted by L(S), which is aligned on the z-axis, and which has a length l equal to the total length of the 3-D target segment S of path P. Then, the technique comprises elastically warping this cylinder in order to fit the given 3-D segment S of path P. Referring to FIG. 1A, the technique comprises:

Using computing means 21 for yielding a 3-D path S that corresponds to the centerline of a tubular segment B of the object of interest OI, as illustrated by FIG .6A and FIG. 6B;

Using computing means 31 for creating an initial straight deformable cylindrical mesh model L(S), of any kind of mesh, with a length l defined along its longitudinal axis z equal to the length of the 3-D segment S; and defining sub-segments u(S) on said 3-D segment S and dividing this initial mesh model L(S) into sub-segments related to the different sub-segments u(S) of the segment S; and

Using computing means 32 for calculating, for each sub-segment of the mesh, a 3-D rigid transformation that transforms the initial direction of the straight mesh L(S) into the direction of the related 3-D sub-segments u(S), and

Using computing means 40 for applying this rigid transformation to the vertices of the mesh corresponding to that sub-segment for creating a generic cylinder.

However, some artifacts might appear if the 3-D segment S is not smooth, for example because the direction between two consecutive sub-segments u(S) changes quickly. Then, the warped cylinder might cross itself, thus leading into undesirable apparition of self-intersections of the mesh when.

This might also lead to an undesirable torsion of the resulting mesh. The mesh torsion is due to lack of continuity control during the transformation.

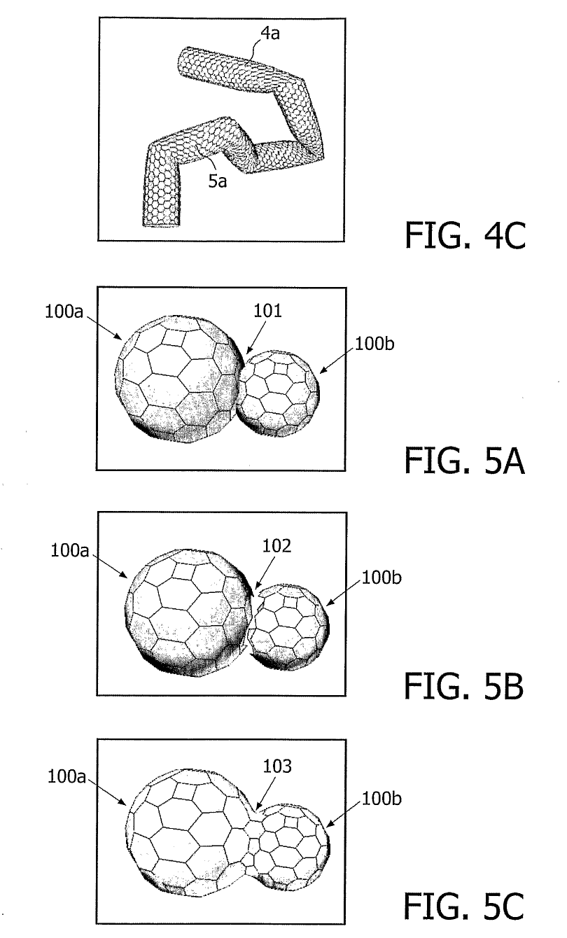

Self-intersections can be avoided if a unique transformation is not applied for each sub-segment. Instead, the rigid-body transformations, which are related to successive sub-segments, are blended in between two consecutive sub-segments. Favorably, rigid-body transformations are blended using linear interpolation between two rotations. FIG. 3A and FIG. 3B illustrate respectively mesh creation without and with linear transformation blending, in circle views. FIG. 3A and FIG. 3B show the effect of rotation blending on a 3-D segment S having quite large orientation change from one sub-segment to the other. In FIG. 3A, it can be seen that, without 3-D rotation blending, the different circles intersect at the junction points, such as points 1a, 2a, 3a, and the generated simplex mesh contains some self-intersections. In FIG. 3B, it can be seen that the linear blending of the rotations helps the different circles to being deformed smoothly from one direction to the following one, resulting in a much more regular mesh, as shown at points 1b, 2b, 3b. FIG. 4A and FIG. 4B illustrate respectively mesh creations without and with linear transformation blending, in simplex mesh views. The mesh models of FIG. 4A and FIG. 4B correspond respectively to mesh creations of FIG. 3A and FIG. 3B.

Linear blending of 3-d rigid transformation from one segment to the other does not always suffice to avoid self-intersections. Clearly, such self-intersections also depend on the relation between the local curvature of the 3-D segment S and the desired radius of the created mesh C(S). If the latter is larger than the local radius of curvature, knowing that the radius of curvature is inversely proportional to the curvature, thus it is small when the curvature is high, then self-intersections occur. Thus, even if a smooth evolution of the rigid body transformation along with the coordinates is assured by the above-described operation of linear-blending, some self-intersection might still appear. The relation that exists between the radius, denoted by r, of the initial straight cylinder L(S), the distance separating two consecutive circles, and the curvature, denoted by c, of the 3-D segment S, might influence the creation of such self-intersections. Trying to warp a cylinder with a large radius r on a very bent path will certainly lead to some serious problems. Hence, it is desirable to automatically reduce locally the diameter of the cylinder C(S) in highly curved zones.

According to the invention, the mesh radius is adapted automatically, based on the curvature and sample distance of the points and the desired input radius. The system of the invention for tubular mesh creation comprises processing means for modulating the radius of the cylindrical mesh according to the local curvature. Hence, the system comprises automatic means for avoiding self-intersections in the bent regions of the tubular deformable mesh model together with sharp radius changes from one sub-segment of the mesh model to the other, including computing means for modulating the radius of the cylindrical deformable mesh model according to the local curvature of the 3-D path. A shrinking factor combined with the 3-D rotation is calculated. Since the invention is related to organs, it is assumed that the provided segment S is smooth enough to use simple approximations. This shrinking factor depends on the radius of the initial cylinder r and the estimated radius of curvature, equal to 1/c, of the 3-D segment S.

Also, it may be difficult to visualize some regions where the radius is not restricted, because regions may be hidden by the bends of other regions. When the mesh model is created using radius modulation, the self-intersections are largely reduced. However, the general shape of the organ is not perturbed in the regions of restricted radii. In the other parts, the radius is unchanged. In regions of restricted radii, visualization and following of the different regions of the organ is greatly improved.

Now, mesh torsion is minimized when the distance between two consecutive rotations, i. e. rigid-body transformations, is minimal. The image processing system comprises automatic means for minimizing mesh torsion, including computing means for computing the minimal 3-D rotation from the initial mesh direction to a target segment. The 3-D rotation is computed as the minimal rotation from the initial mesh direction, which is the z-axis, to the target sub-segment u(S). Favorably, the image processing system comprises automatic means for defining incremental rotation between segments with an axis parameter and with a rotation angle parameter and computing these parameters iteratively from one segment to the other so that the new rotation for a current sub-segment is computed as a composition of the found rotation for the previous sub-segment and the minimal rotation from the previous and the current sub-segment. FIG. 4C and FIG. 4B illustrate minimal torsion obtaining by using incremental rotation. FIG. 4C shows an example of mesh creation using only minimal rotation between the z-axis and u(s). FIG. 4B shows an example of mesh creation further using an incremental rotation leading to a minimal torsion. In FIG. 4C, it can be seen that torsion appears on the mesh because the cells are twisted around junction points, for example in regions 4a and 5a. Instead, in FIG. 4B, the cells are kept well aligned all over the mesh, such as in regions 4b and 5b corresponding to the regions 4a and 5a of FIG. 4C.

The above described technique works with different kinds of 3-D paths. However, the best results are observed when no sharp angles are present. Hence, it is better to preliminary smooth the input 3-D path using any smoothing technique known to those skilled in the art. Still better results are also obtained when the segment lengths of the path are homogeneous. After all these precautions, if self-intersections still exists, then automatic mesh repairing, smoothing with internal force of the active contour algorithm might be applied, as described in the introduction part in relation with the transformations described in the prior art.

Now, as illustrated by FIG. 7A, generic bent cylindrical meshes, which are labeled M0, M01, M02, M021 and M022 are available corresponding to the segments of path P labeled S0, S01, S02, S021, and S022. As illustrated by FIG. 1A, the system of the invention has further means 50 for fusing by two the previously generated bent cylindrical meshes, as illustrated by FIG. 7B and FIG. 7C.

According to the invention, preferably, mesh fusions are made as few as possible. The system has processing means to minimize the number of mesh fusions. Since the system has means 11 to automatically label the generated tree-like mesh surface according to the various branches of the initial tree, the labeling defines various regions of the final mesh. For minimizing the number of fusions, referring to FIG. 1A, means 40 of the system generates a first cylindrical structure from the greatest possible number of adjacent centerline segments, in a continuous manner. Then, the remaining cylindrical structures are fused one by one with this first cylindrical structure.

Referring to FIG. 7A, in an example, a first cylindrical structure M0 is constructed following the continuous path S0 formed of the adjacent segments S0, S02 and S022, as illustrated by FIG. 6B. Then other cylindrical structures are fused to this first cylindrical structure. Creating this first cylindrical structure M0, which directly forms a main branch from several adjacent centerline segments, to which other branches are fused, minimizes the number of fusions operations. The same principle may be applied to the other branches with sub-branches. In the example of FIG. 7A, the first generic cylinder labeled M0, formed from M0, M02, M022, is fused with the generic cylinder M01 corresponding to path S01, as illustrated by FIG. 7B. This first generic cylinder M0 is further fused with the generic cylinder M022 corresponding to path S022, as illustrated by FIG. 7C.

Referring to FIG. 1B, the fusion means 50 of the system of the invention has sub-means 51 for the detection of intersection of two meshes. The system then has sub-means 52 for elimination of intersecting cells or for mesh opening if necessary. For elimination of intersecting faces and mesh opening, intersecting faces are tagged. The tag faces of the mesh are deleted and the holes are retained.

Referring to FIG. 1C and illustrated by FIG. 5A to FIG. 5C, the fusing means 50 further comprise in details:

Detection means 51 of the intersection cells using binary volumes of two meshes. Two meshes, such as the spheres 100a, 100b shown in FIG. 5A, are binarized using a binarization function. The question of binarization resolution may be quite important, as some intersections might be missed when binarization resolution is too low. Then, each vertex of one mesh is tested to know whether it belongs to the binary volume of the opposite mesh. If the answer is positive, the faces in which the vertex belongs to are tagged with a FACE_INSIDE label.

Elimination means 52 of the detected intersection cells: All faces tagged FACE_INSIDE are deleted in both meshes. FIG. 5B illustrates the elimination of the intersecting cells in region 102 in the case of the two spherical meshes 100A, 100b.

Detection means 53 of the intersection contours in two meshes: Open contours in two meshes are looked for.

Pairing means 54 for pairing open contours: In current implementation, the pairing is based on the proximity of the centers of gravity of the contours. This simple criterion seems to work reasonably well, but of course a more sophisticated one can be found if the need arise.

Linking means 55 for linking the corresponding pairs of intersection contours: Each pair of contours is treated separately. For each pair, first mutually closest vertices are found on two contours and linked. As the number of vertices on the contours might not be equal and their distribution might not be necessarily similar, it is taken care of the remaining “open” vertices. These open vertices are located between the already linked ones. The part of the contour between two linked vertices is called a segment. All segments are coupled (i.e., each segment has a corresponding segment at the opposite contour), as their both end-points are linked. For each open vertex of a segment, a new vertex is inserted in the opposite segment, and then linked. The new vertex gets the same relative position within its segment as the corresponding open vertex at the opposite segment.

Face generation means 56: New face generation is done based on following the closed contours, starting from the previously linked vertices. All topological relations for the newly created faces are also established. FIG. 5C illustrates the face generation in region 103 between the spherical meshes 100a, 100b.

If the two meshes have very different cell resolutions, the detection of the intersection faces may fail. For example, if a sphere with very large cells intersects a cylinder whose diameter is smaller than a cell size of the sphere, it may happen that no vertex of the sphere is detected inside the binary volume of the cylinder. On the other hand, the intersection of the cylinder with the sphere's binary volume will be found. So, this case can be detected. A possible solution for such situation would be to refine one object, for example the sphere, till it has the similar cell resolution with the second mesh, which is the cylinder in this example.

Medical Viewing System and Apparatus

FIG. 8 shows the basic components of an embodiment of an image viewing system in accordance to the present invention, incorporated in a medical examination apparatus. The medical examination apparatus 151 may include a bed 110 on which the patient lies or another element for localizing the patient relative to the imaging apparatus. The medical imaging apparatus 151 may be a CT scanner or other medical imaging apparatus such as x-rays or ultrasound apparatus. The image data produced by the apparatus 151 is fed to data processing means 153, such as a general-purpose computer, having instructions to process the image data as described above. The data processing means 153 is typically associated with a visualization device, such as a monitor 154, and an input device 155, such as a keyboard, or a mouse 156, pointing device, etc. operative by the user so that he can interact with the system. The data processing device 153 is programmed to implement the system of the invention using fully automatic means. In particular, the data processing device 153 has computing means and memory means. A computer program product having pre-programmed instructions to operate the system may also be implemented. The invention also relates to a medical image processing method, for the automatic segmentation of tubular tree-like body organs such as arteries, for improving the visualization of the organs, said method having steps for operating the image processing system.

The drawings and their description herein before illustrate rather than limit the invention. It will be evident that there are numerous alternatives that fall within the scope of the appended claims. Moreover, although the present invention has been described in terms of generating image data for display, the present invention is intended to cover substantially any form of visualization of the image data including, but not limited to, display on a display device, and printing. Any reference sign in a claim should not be construed as limiting the claim.

1. An image data processing system with computing means for fully automatic segmentation of a treelike tubular structure in a 3-D image comprising:
means (20) for computing a treelike center path of the tubular treelike structure;
means (21) for dividing the treelike center path of the tubular treelike structure into segments formed of points;
means (40) for generating generic cylindrical meshes formed of cells, for individual segments of the treelike center path;
means (50) for fusing generic cylindrical meshes by two.

2. The image processing system of claim 1, wherein means (50) for fusing generic cylindrical meshes comprises: Detection means (51) of the intersection of the two generic cylindrical meshes; Elimination means (52) of the detected intersection cells yielding open contours in the two generic cylindrical meshes; Detection means (53) of said open contours for forming intersection contours; Pairing means (54) for pairing intersection contours of the two generic cylindrical meshes; Linking means (55) for linking the corresponding pairs of intersection contours; Face generation means (56) for generating new faces following the intersection contours.

3. The image processing system of claim 1, wherein the means of segmentation comprise means for minimizing the number of fusions including:
label means (21) to automatically label the generated tree-like path segments according to the various regions of the initial tubular treelike tubular structure; generating means (31) for generating a number of generic cylindrical meshes from the greatest possible number of adjacent centerline segments corresponding to a corresponding number of regions of the initial tubular treelike tubular structure, in a continuous manner; fusing means (50) for fusing these generic cylindrical meshes between them into one tree-like mesh.

4. The image processing system of claim 1, wherein the means 40 for generating generic cylinders comprise:
generating means (31) for creating a deformable tubular mesh model for fitting a 3-D path segment composed of a set of ordered points and automatically adapting the mesh radius based on the curvature of the 3-D path and sample distance of the path points and a predefined input radius.

5. The image processing system of claim 4, wherein the generating means (31) comprises computing means for creating an initial straight deformable cylindrical mesh model (L), of any kind of mesh, with a length defined along its longitudinal axis equal to the length of the 3-D segment of path; for dividing this initial mesh model into segments of length related to the different sub-segments of the 3-D segment of path; for computing, for each segment of the mesh, a rigid-body transformation that transforms the initial direction of the mesh into the direction of the related sub-segment of the 3-D segment of path; and for applying this transformation to the vertices of the mesh corresponding to that sub-segment.

6. The image processing system of claim 5, comprising means for computing rigid-body transformations related to the successive sub-segments, which transformations, are blended in between two consecutive sub-segments.

7. The image processing system of claim 6, comprising means for limiting self-intersections between bent parts of the mesh model, comprising computing rotations for rigid-body transformations between consecutive sub-segments, wherein a linear interpolation is used between two rotations for 3-D rigid body transformation blending.

8. The image processing system of claim 5, comprising means for avoiding self-intersections in the bent regions of the tubular deformable mesh model together with sharp radius changes from one sub-segment of the mesh model to the other, including computing means for modulating the radius of the cylindrical deformable mesh model according to the local curvature of the 3-D path.

9. The image processing system of claim 5, comprising means for minimizing mesh torsion, including computing means for computing the minimal 3-D rotation from the initial mesh direction to a target segment.

10. The image processing system of claim 9, comprising means for defining rotation between segments with an axis parameter and with a rotation angle parameter and computing these parameters iteratively from one segment to the other so that the new rotation for a current sub-segment is computed as a composition of the found rotation for the previous sub-segment and the minimal rotation from the previous and the current sub-segment.

11. A medical viewing system comprising means for acquiring 3-D medical image data of a 3-D tree-like tubular organ, a suitably programmed computer or a special purpose processor having circuit means, which are arranged to form a processing system as claimed in claim 1; and display means to display the medical images.

12. A medical examination apparatus comprising means for acquiring 3-D medical image data of a 3-D tree-like tubular organ and having an automatic processing system as claimed in claim 1 to process the images; and display means to display the medical images.

13. A computer program product comprising a set of instructions for operating the system of claim 1.

14. An image processing method having steps to operate the automatic means of the system according to claim 1.
